(19) United States
(12) Patent Application Publication
(10) Pub. No.: US 2012/0280090 A1
(43) Pub. Date: Nov. 8, 2012

(54) CONNECTING DEVICE PARTICULARLY ADAPTED FOR THE CONNECTION BETWEEN AN AIR INTAKE AND AN ENGINE OF AN AIRCRAFT NACELLE

(75) Inventors: Alain PORTE, Colomiers (FR); Stéphane DIDA, Fontenilles (FR); Martial MARRO, Plaisance Du Touch (FR); Julian REED, Derby (GB); David WATTAM, Derby (GB); Colin WOODWARD, Derby (GB); Caroline HALLIDAY, West Kilbride (GB)

(73) Assignees: ROLLS-ROYCE PLC, London (GB); AIRBUS OPERATIONS SAS, Toulouse (FR)

(21) Appl. No.: 13/358,651

(22) Filed: Jan. 26, 2012

(30) Foreign Application Priority Data
Jan. 26, 2011 (FR) 11 50609

(51) Int. Cl. B64D 29/06; F16L 21/00

(52) U.S. Cl. 244/53 B; 285/419

(57) ABSTRACT

A connecting device between two cylindrical parts that are connected at a junction plane, more particularly suited for connecting an air intake and a power plant of an aircraft nacelle, includes—at the parts to be connected—a large number of through holes that are perpendicular to the junction plane and that empty out at the junction plane, arranged facing one another and connecting elements housed in the through holes, each including a rod with supports at each end that make it possible to keep the parts to be connected flattened. The through holes include—for each—at least one small cross-section that is adjusted to the rod of the connecting element close to the corresponding support and a cross-section with significant play at the junction plane so that the rod only undergoes very weak shear forces at the junction plane during the relative deformation of the assembled parts.

This invention relates to a connecting device that is more particularly suited for ensuring the connection between an air intake and a power plant of an aircraft nacelle.

An aircraft propulsion system comprises a nacelle in which a power plant that is connected by means of a mast to the rest of the aircraft is arranged in an essentially concentric manner.

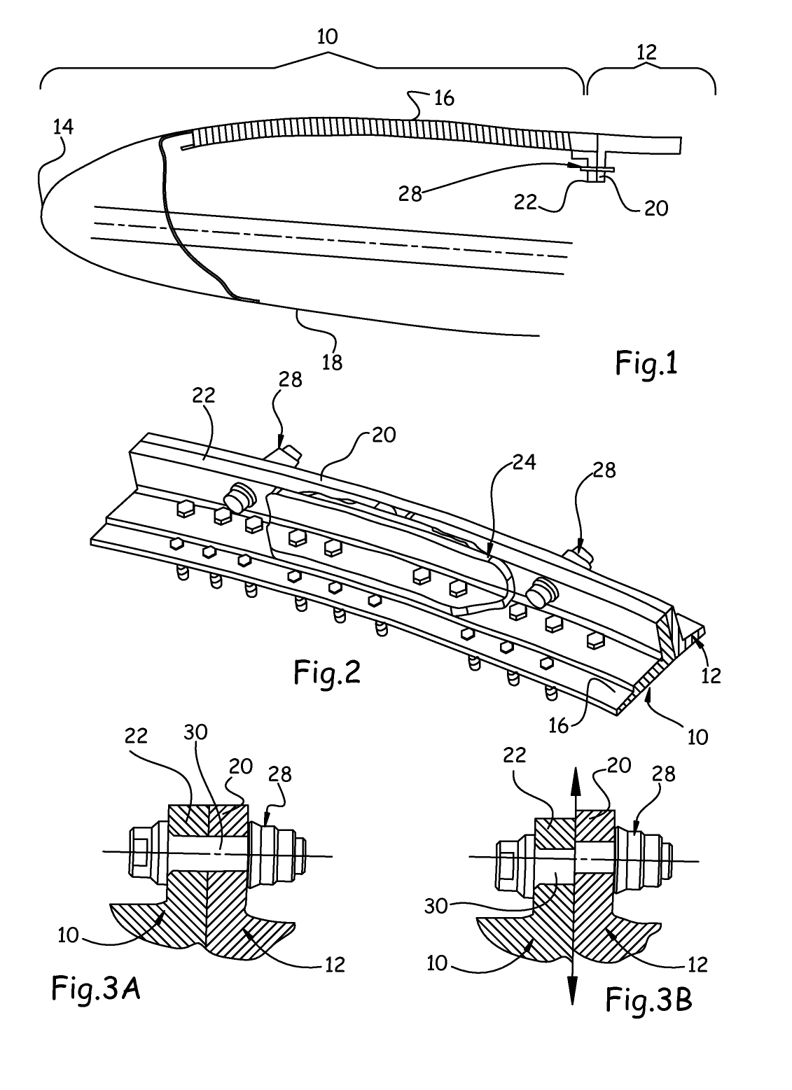

As illustrated in FIG. 1, the nacelle comprises an air intake 10 at the front that makes it possible to channel a stream of air in the direction of the power plant 12, with a first portion of the incoming air stream, called the primary stream, passing through the power plant to participate in the combustion, and with the second portion of the air stream, called the secondary stream, being driven by a fan and flowing into an annular pipe that is delimited by the inside wall of the nacelle and the outside wall of the power plant.

The air intake 10 comprises a lip 14 whose surface that is in contact with the aerodynamic streams is extended inside the nacelle by an inside pipe 16 with essentially circular cross-sections and outside of the nacelle by an outside wall 18 with essentially circular cross-sections.

The air intake 10 is connected to the power plant 12 by a connecting device that is illustrated in detail in FIGS. 2, 3A, and 4A. At the power plant, this connecting device comprises a first annular collar 20 that is made integral with a second annular collar 22 with a panel that delimits the pipe 16 or a separating piece 24, called a flange, connected to the panel that delimits the pipe 16, as illustrated in FIG. 2. The two collars 20 and 22 are flattened against one another and thus held by connecting elements 28, for example bolts or rivets, which pass through the collars 20, 22 and extend parallel to the longitudinal axis of the nacelle.

According to a first embodiment that is illustrated in FIG. 3A, the bolts or rivets 28 comprise a rod 30 whose diameter can be adjusted to that of the through holes made in the annular collars 20 and 22.

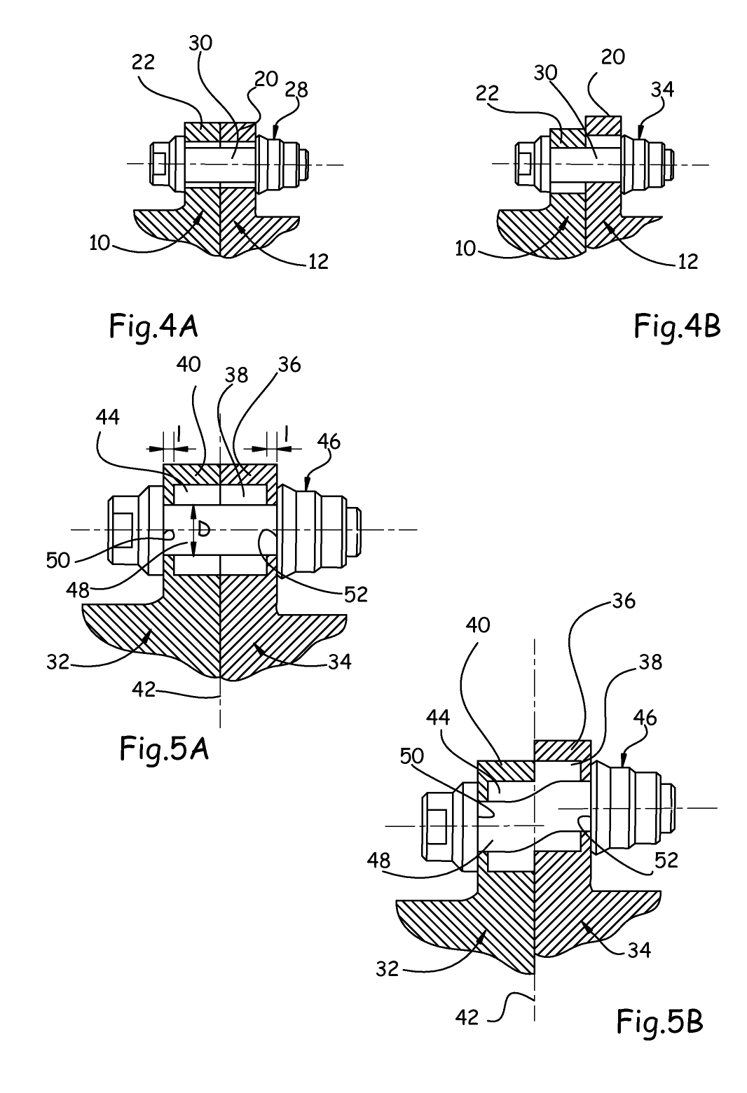

According to a second embodiment that is illustrated in FIG. 4A, the diameter of the through holes made in the annular collars 20 and 22 can be slightly larger than that of the rod 30 of the bolts or rivets 28. This play between the through holes and the bolts or rivets 28 allows a relative movement between the two connected elements.

In the two cases, the through holes are cylindrical.

The connecting device and more particularly the bolts or rivets 28 are sized to remedy possible risks of incidents, such as, for example, the breaking of a fan blade.

In this case, the pipe of the power plant can become deformed over its entire periphery. During these deformations, the through holes of the annular collar of the power plant are no longer arranged facing those of the air intake, as illustrated in FIGS. 3B and 4B. In this configuration, the bolts or rivets 28 undergo in particular relatively significant shearing stresses that are clearly greater than the stresses undergone in normal operation. Even if the second embodiment allows a relative movement between the two parts that are connected because of the play that is present around the bolts or rivets 28, this play is clearly less than the relative movement between the two connected parts in the event of an incident, such as the breaking of a blade. In the case of the second embodiment with play, it is noted that the shearing stresses are at least equal to—and even greater than—those that are present for the first embodiment.

To withstand such stresses, the connecting device comprises a given number of bolts or rivets 28 with a given diameter.

Taking into account the strength of a bolt or a rivet 28 in an assembly in accordance with the embodiments illustrated in FIGS. 3A and 4B, this leads to providing a large number of bolts or rivets 28 and/or bolts or rivets 28 with a large diameter for the connecting device, which produces a larger on-board weight and consequently a more significant energy consumption of the aircraft.

Also, the purpose of this invention is to propose a connecting device that is more particularly suited for connecting a power plant and an air intake of an optimized aircraft nacelle that makes it possible to reduce the on-board weight.

For this purpose, the invention has as its object a connecting device between two pipes that are connected at a junction plane, more particularly suited for connecting an air intake and a power plant of an aircraft nacelle, with said connecting device comprising—at the pipes to be connected—a large number of through holes that are perpendicular to the junction plane and that empty out at the junction plane, arranged facing one another and connecting elements housed in the through holes, each comprising a rod with supports at each end that make it possible to keep said parts flattened, characterized in that said through holes comprise—for each—at least one small cross-section that is adjusted to the rod of the connecting element close to the corresponding support and a cross-section with significant play at the junction plane in such a way that said rod only undergoes very weak shear forces at the junction plane during the relative deformation of the pipes.

According to the invention, the connecting device between the air intake and the power plant can absorb a portion of the energy that is produced when a blade is broken, for example by plastic and elastic deformation of said connecting device. In addition, using geometric shapes of the through holes, the connecting elements have greater strength. This makes it possible to limit the number and/or the oversizing of the connecting elements, and therefore the on-board weight, by significantly reducing the shearing stresses undergone by said connecting elements.

Other characteristics and advantages will emerge from the following description of the invention, a description that is provided only by way of example, relative to the accompanying drawings in which:

FIG. 1 is a diagrammatic cutaway along a radial plane of a portion of the front of an aircraft nacelle,

FIG. 2 is a perspective view that illustrates a portion of a connection between an engine and an air intake of an aircraft nacelle according to the prior art,

FIG. 3A is a cutaway that illustrates a connecting element between an engine and an air intake of an aircraft nacelle according to a first embodiment of the prior art,

FIG. 3B is a cutaway that illustrates the connecting element of FIG. 3A that undergoes shearing stresses,

FIG. 4A is a cutaway that illustrates a connecting element between an engine and an air intake of an aircraft nacelle according to a second embodiment of the prior art,

FIG. 4B is a cutaway that illustrates the connecting element of FIG. 4A that undergoes shearing stresses,

FIG. 5A is a cutaway that illustrates a connecting element between an engine and an air intake of an aircraft nacelle according to a first variant of the invention,

FIG. 5B is a cutaway that illustrates the connecting element of FIG. 4A during a deformation,

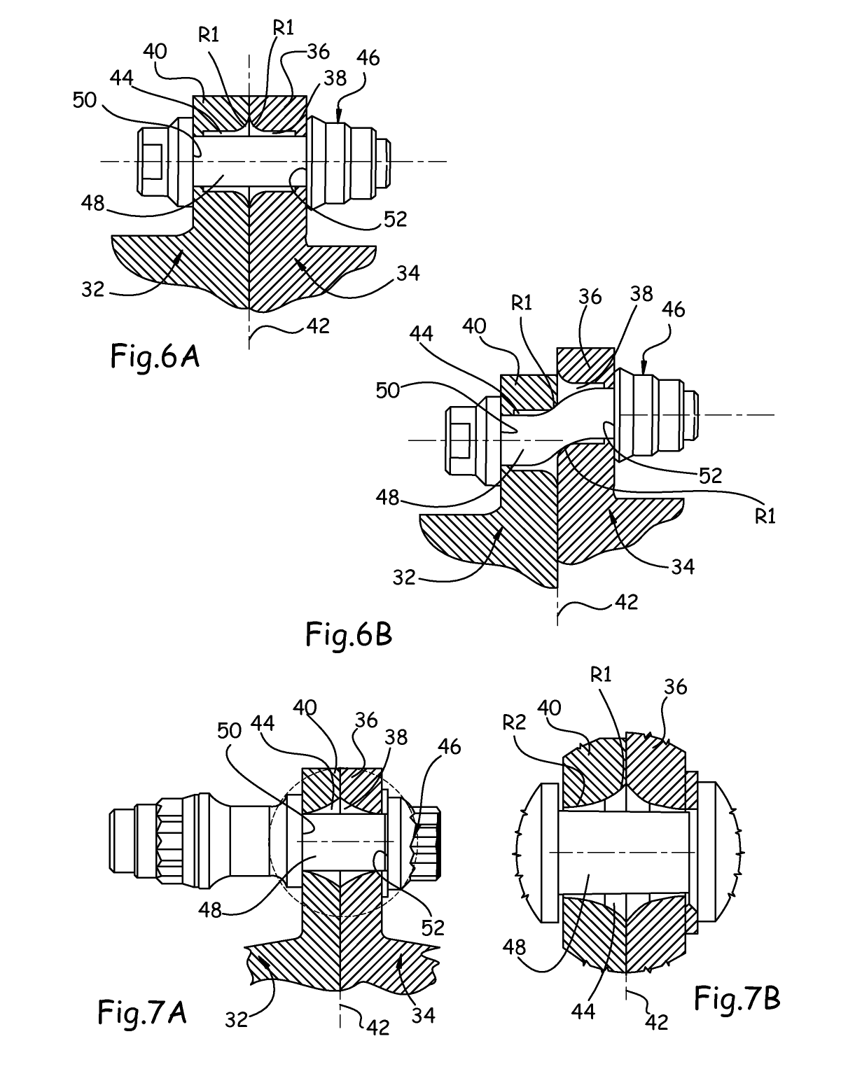

FIG. 6A is a cutaway that illustrates a connecting element between an engine and an air intake of an aircraft nacelle according to a second variant of the invention,

FIG. 6B is a cutaway that illustrates the connecting element of FIG. 6A during a deformation,

FIG. 7A is a cutaway that illustrates a connecting element between an engine and an air intake of an aircraft nacelle according to a third variant of the invention,

FIG. 7B is a cutaway that illustrates details of FIG. 7A,

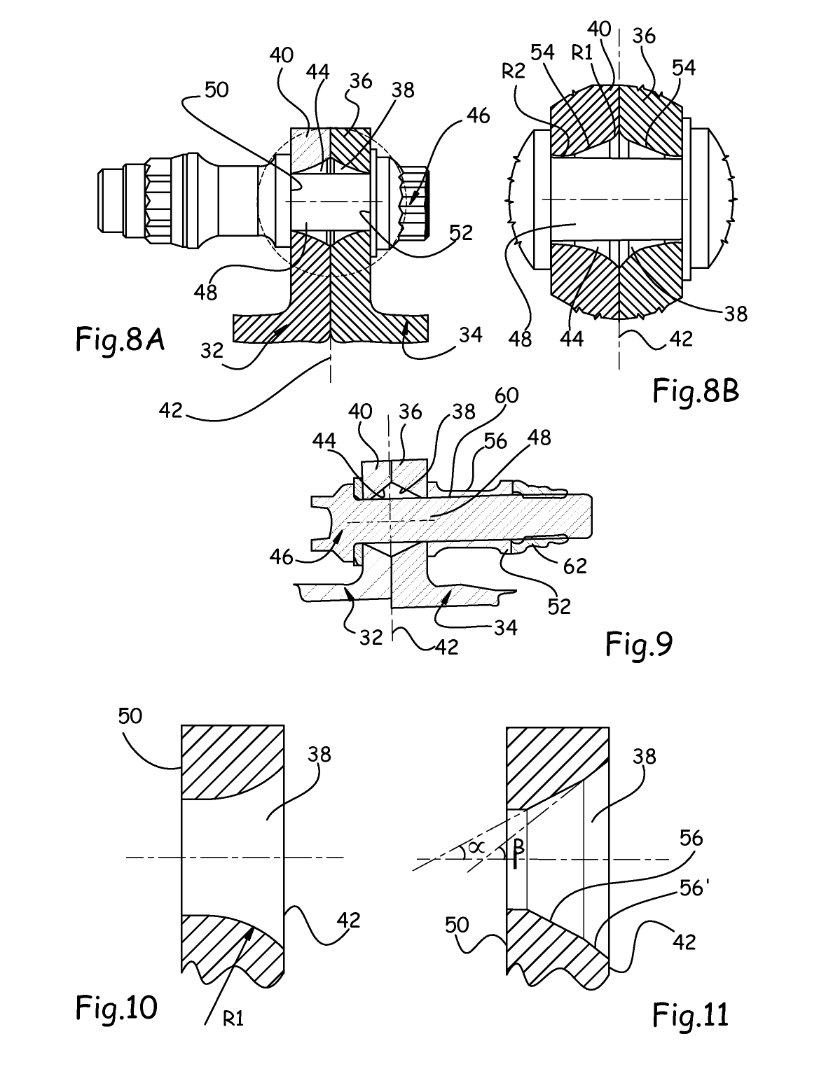

FIG. 8A is a cutaway that illustrates a connecting element between an engine and an air intake of an aircraft nacelle according to a fourth variant of the invention,

FIG. 8B is a cutaway that illustrates details of FIG. 8A,

FIG. 9 is a cutaway that illustrates a connecting element between an engine and an air intake of an aircraft nacelle according to another variant of the invention,

FIGS. 10 to 13 are cutaways that illustrate variants of through hole profiles,

FIG. 14 is a cutaway that illustrates in detail a connecting element according to a variant of the invention, and

FIG. 15 is a cutaway that illustrates in detail a connecting element according to another variant of the invention.

In FIGS. 5A, 5B, 6A, 6B, 7A, 7B, 8A, 8B and 9, the junction zone between an air intake 32 and a power plant 34 of an aircraft nacelle is shown in cutaway.

According to one embodiment, the connecting device between a power plant and an air intake comprises—at the power plant—an annular collar 36 that extends in a plane that is essentially perpendicular to the longitudinal axis of the nacelle and that comprises a large number of through holes 38, and—at the air intake—an annular collar 40 that extends in a plane that is essentially perpendicular to the longitudinal axis of the nacelle, flattened against the annular collar 36 of the power plant at a junction plane that is referenced 42 and that comprises a large number of through holes 44 arranged facing through holes 38 of the power plant and connecting elements 46 that are distributed over the periphery of the annular collars 36 and 40 that are housed in the through holes 38 and 44.

As appropriate, an annular collar can be produced integrally with the power plant or the air intake or can come in the form of a flange that is connected to the power plant or the air intake.

Although described as applied to the connection between an air intake and a power plant of an aircraft nacelle, the connecting device can be used to connect two pipes whose connection may be stressed by radial forces.

Each connecting element 46 comprises a rod 48 in the form of a cylinder with, at a first end, a first support 50 that can be flattened against the free surface of one of the collars, in this case the annular collar 40 of the air intake, and, at the other end, a second support 52 that can be flattened against the free surface of the other collar, in this case the annular collar 36 of the power plant.

According to one embodiment, a connecting element 46 can come in the form of a bolt, with, on the one hand, a screw that comprises a rod with a head (corresponding to the first support 50) at a first end and a threading at the other end, and, on the other hand, a screw nut (corresponding to the second support 52) that is screwed at the end of the screw.

As a variant, the connecting element can come in the form of a rivet with a rod that comprises a head that forms a first support 50 at a first end and whose other end is deformed in such a way as to form the second support 52.

The rod 48 of the connecting element has a diameter D that is determined based on stresses that are undergone essentially in terms of traction.

Contrary to the prior art for which the connecting elements are sized to withstand stresses of which the most critical are the shearing stresses because of non-alignment of the through holes, for example when a blade is broken, the purpose of the invention is to propose a connecting device that makes it possible to absorb—by plastic and elastic deformation—a portion of the energy that is produced during the impact of the blade against the pipe of the power plant. This makes it possible to limit the number and/or the oversizing of the connecting elements, and therefore the on-board weight, by essentially reducing the shearing stresses undergone by said connecting elements.

For this purpose, according to the invention, the through holes 38 and 44 are not cylindrical but for each one comprise at least one cross-section that is adjusted to the rod 48 of the connecting element close to the corresponding support 50 or 52 and a cross-section with significant play at the junction plane 42.

An adjusted cross-section is defined as the diameter of the through hole 38 or 44 being equal to the diameter of the rod 48 or being within a tolerance range of +/−1 mm.

According to the invention, the guide rod is perfectly guided at supports 50 and 52 and can become deformed at the junction plane 42.

This arrangement makes it possible for connecting elements 46 to absorb a portion of the energy produced during the impact of the blade against the pipe of the power plant by plastic and/or elastic deformation. In addition, the rod 48 is subjected to shearing stresses that are less significant than according to the prior art although it is possible to reduce the number and/or the diameter of the connecting elements 46.

According to a first embodiment that is illustrated in FIGS. 5A and 5B, for each collar 36, 40, the through hole 44, 38 comprises a bearing with a cross-section that is adjusted to that of the rod 48 over a distance 1 that extends from the free surface in contact with one of the supports 50 and 52, with 1 being less than ⅓ of the total length of the through hole 38, 44. Over the rest of the thickness of the collar 36, 40, the through hole 38, 44 has a diameter that is considerably larger than that of the rod 48. Considerably larger means that the diameter of the through hole 38, 44 has a value that is greater than D+10%, with D being the diameter of the rod 48.

Preferably, the through holes 38 and 44 have a tapered shape in the direction of the junction plane 42.

According to a first variant that is illustrated in FIGS. 6A, 6B, and 10, the through holes 38 and 44 empty out at the junction plane 42 by tapered shapes that have a curvature radius R1 at the junction plane 42.

As illustrated in FIG. 6B, this curvature radius R1 makes it possible to increase the rupture strength of the rod 48. During the deformation of the rod 48, a hardening phenomenon appears when said rod comes into contact with the rounded shape R1.

According to the variant that is illustrated in FIG. 10, the curvature radius R1 is such that its tangent at supports 50 or 52 is parallel to the axis of the rod 48.

According to another improvement illustrated in FIGS. 7A and 7B, the through holes 38 and 44 have a cross-section that gradually tapers to the junction plane 42. In addition to having a curvature radius R1 at the junction plane, the through holes 38 and 44 each have a curvature radius R2 in accordance with the smallest cross-section.

This configuration makes it possible to reduce the shearing stresses, which tends to increase the rupture strength of the rod 48.

Preferably, as illustrated in FIGS. 8A and 8B, the radius R2 is less than the radius R1.

Advantageously, between the radii R1 and R2, the generatrices of the through holes comprise an essentially rectilinear portion 54.

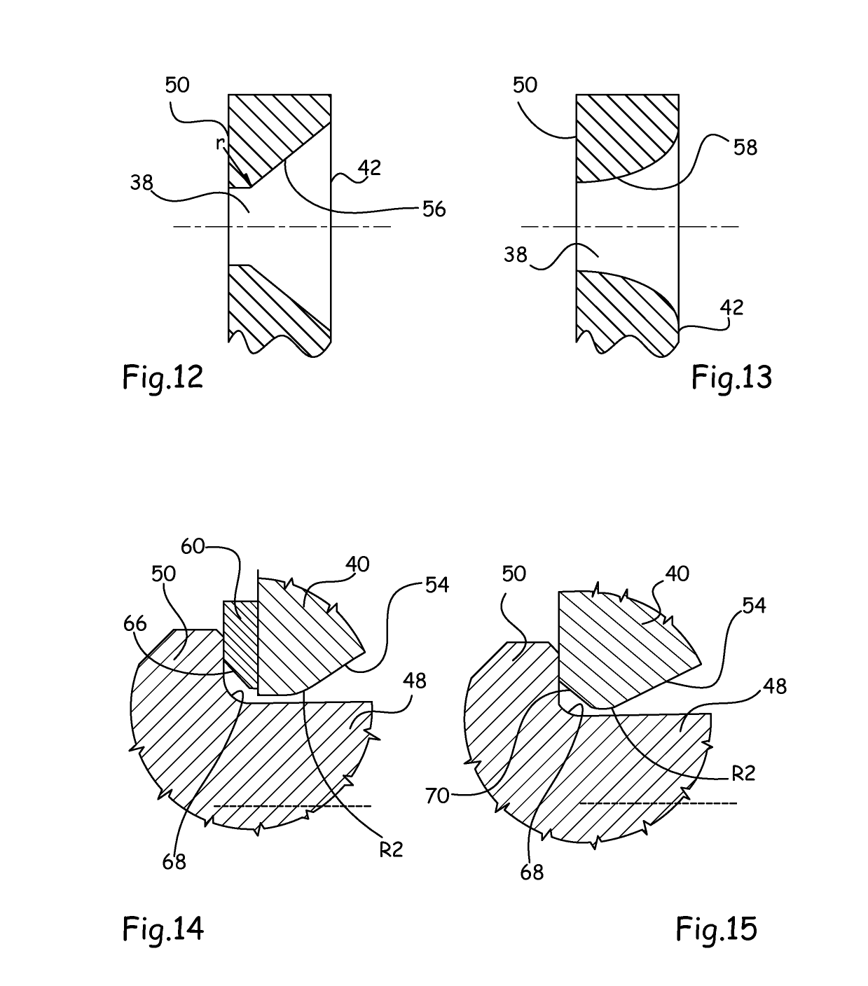

According to another variant that is illustrated in FIGS. 9, 11 and 12, the through hole 38 or 44 comprises at least one truncated shape that is tapered in the direction of the junction plane 42. According to one variant that is illustrated in FIG. 12, the through hole 38 or 44 comprises a single truncated portion 56 that is tapered in the direction of the junction plane 42 that is connected to the adjusted portion by a sharp ridge or preferably by a curvature radius.

According to a variant that is illustrated in FIG. 11, the through hole 38 or 44 comprises at least two truncated portions 56, 56′ that are tapered in the direction of the junction plane 42. The first truncated portion 56, the closest of the support 50 or 52, forms an angle α with the axis of the through hole, and the second truncated portion 56′, closest to the junction plane 42, forms an angle β.

Preferably, the angle β is greater than the angle α, with the truncated portions increasingly tapering close to the junction plane 42. If appropriate, the truncated portions are connected by sharp ridges and/or by curvature radii.

According to another variant that is illustrated in FIG. 13, the through hole 38 or 44 can have an essentially elliptical-shaped profile 58, namely a tangent to the support plane that is parallel to the axis of the through hole and a tangent to the junction plane 42 that is perpendicular to the axis of the through hole.

According to the invention, the profile of the through holes can comprise a combination of curves that are tapered in the direction of the junction plane 42.

As illustrated in particular in FIG. 9, at least one deformable sheath 60 can be slipped onto the rod 48 and inserted between one of the collars and one of the supports. According to the illustrated example, the deformable sheath 60 is inserted between the annular collar 36 of the power plant and the support 52 that is formed by a screw nut 62 of the connecting element. This deformable sheath 56 has an inside diameter that is adjusted to that of the rod 48 and comprises—in the central portion—a relatively small thickness in such a way as to follow the curvature of the rod during its deformation. This arrangement makes it possible to increase the energy that is absorbed by deformation of the connecting device.

As illustrated in FIG. 14, a washer 64 can be slipped onto the rod 48 and inserted between the support 50 (or 52) of the connecting element and the annular collar 40 of the air intake (or the collar of the power plant 36).

Advantageously, the shapes of the washer 64 are adapted to obtain a ball-joint effect between the support 50 (or 52) of the connecting element and the annular collar 40 (or 36).

According to another embodiment that is illustrated in FIG. 14, the washer 64 comprises a flat surface facing the annular collar 40 (or the collar 36) and a beveled edge 66 at its through hole. In addition, the support 50 and the rod 48 of the connecting element are connected by a curvature radius 68.

According to an embodiment that is illustrated in FIG. 15, the terminal portion of the through hole 38 or 44 that is oriented toward the free surface of the collar can comprise a rounded or beveled-edge shape 70. According to this embodiment, the through hole 38 or 44 has a diameter that decreases over 1 to 2 mm and then increases up to the junction plane as illustrated in FIG. 11.

1. Connecting device between two parts that are connected at a junction plane (42), more particularly suited for connecting an air intake and a power plant of an aircraft nacelle, with said connecting device comprising—at the parts to be connected—a large number of through holes (38, 44) that are perpendicular to the junction plane and that empty out at the junction plane (42), arranged facing one another and connecting elements (46) housed in the through holes (38, 44), each comprising a rod (48) with supports (50, 52) at each end that make it possible to keep said parts to be connected flattened, characterized in that said through holes (38, 44) comprise—for each—at least one small cross-section that is adjusted to the rod (48) of the connecting element close to the corresponding support (50, 52) and a cross-section with significant play at the junction plane (42) in such a way that said rod (48) only undergoes very weak shear forces at the junction plane during the relative deformation of the assembled parts.

2. Connecting device according to claim 1, wherein the through holes (38, 44) empty out at the junction plane (42) by a tapered shape.

3. Connecting device according to claim 2, wherein the through holes (38, 44) have a curvature radius R1 at the junction plane (42).

4. Connecting device according to claim 2, wherein the through holes (38, 44) each have a curvature radius R2 in the extension of the small cross-section in the direction of the junction plane (42).

5. Connecting device according to claim 4, wherein the curvature radius R2 is less than the curvature radius R1.

6. Connecting device according to claim 1, wherein the through holes (38, 44) comprise at least one truncated shape that is tapered in the direction of the junction plane (42).

7. Connecting device according to claim 6, wherein the through holes (38, 44) comprise at least two truncated portions (56, 56′) that are increasingly tapered close to the junction plane (42).

8. Connecting device according to claim 1, wherein each through hole (38, 44) comprises a bearing with a cross-section that is adjusted to that of the rod (48) over a distance 1 that is less than ⅓ of the total length of the through hole (38, 44).

9. Connecting device according to claim 1, wherein the through holes (38, 44) have a diameter that decreases over 1 to 2 mm and then increases from the support (50, 52) up to the junction plane (42).

10. Aircraft nacelle that comprises an air intake that is connected at a junction plane (42) to a power plant by a connecting device according to claim 1.
